(19) United States
(12) Patent Application Publication
(10) Pub. No.: US 2010/0070373 A1
(43) Pub. Date: Mar. 18, 2010

(54) Auction System

(75) Inventor: Onno Zoeter, Genoble (FR)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/210,654

(22) Filed: Sep. 15, 2008

(51) Int. Cl. G06Q 30/00; G06Q 40/00; G06F 17/00

(52) U.S. Cl. 705/14.71; 705/26; 705/37; 705/400

(57) ABSTRACT

Auction systems receive bids for items and select a winning item during each round of the auction. In an embodiment an automated on-line auction system for sponsored links is described. In the embodiment, for each advertisement a total expected utility is calculated over all advertisements and all anticipated future rounds of the auction. In an embodiment, an advertisement with the highest such total expected utility may be selected as the winner of the round of the auction and the advertiser is charged no matter whether the advertisement is clicked or not. In some embodiments the charge may be related to the externality that the winning advertisement imposes on the current round of the auction which can be thought of as the expected profits foregone by the other advertisers.

### BACKGROUND

Many popular search engines run an auction to select sponsored links or advertisements to place next to search results. For example, when a user enters a keyword, he or she receives search results along with sponsored links. The sponsored links are typically shown in decreasing order based upon received bids. The bids are submitted by advertisers and indicate a maximum willingness to pay for a click for a specific term or keyword. The advertisement with the highest bid may be displayed at the top of the page; the advertisement with the next highest bid may be displayed at the position second from the top and so forth. If a user selects the top-most sponsored link, the advertiser may be charged the amount of the bid for the sponsored link in the second position.

Typically, such auctions are also based on an expected click-through rate of each advertisement. An expected click-through rate (CTR) gives information about how likely a particular sponsored link is to be selected by a user. For example, most known search engines combine an advertiser's bid with an expected CTR for the sponsored link to obtain an expected value. Sponsored links are then presented in decreasing order of expected values. However, click-through rates are not readily observable and need to be learnt from usage data. This is time and opportunity consuming and difficult for practical purposes.

Existing auctions to select sponsored links may be open to manipulation by some advertisers in particular circumstances. Also, advertisers may spend a significant amount of time and money to calculate optimal bids and to monitor and respond to competitors' bids. There is a desire to improve on existing auction systems to encourage bidding and to produce benefits for advertisers, search engines and end users in robust and effective ways.

The embodiments described below are not limited to implementations which solve any or all of the disadvantages of known online auctions for advertisements.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Auction systems receive bids for items and select a winning item during each round of the auction. In an embodiment an automated on-line auction system for sponsored links is described. In the embodiment, for each advertisement a total expected utility is calculated over all advertisements and all anticipated future rounds of the auction. In an embodiment, an advertisement with the highest such total expected utility may be selected as the winner of the round of the auction and the advertiser is charged no matter whether the advertisement is clicked or not. The charge may be related to the externality that the winning advertisement imposes on the current round of the auction which can be thought of as the expected profits foregone by the other advertisers.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of a method for a generalized second price auction;

FIG. 2 is a schematic diagram of an automated auction system;

FIG. 3 is a block diagram of a method at an automated auction system;

FIG. 4 is a block diagram of a method at an automated auction system in a multi-slot case;

FIG. 5 illustrates an exemplary computing-based device in which embodiments of an automated auction system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an online auction system for advertisements, the system described is provided as an example and not a limitation. As those skilled in the art will appreciate, the present examples are suitable for application in a variety of different types of automated auction systems including but not limited to automated auction systems for sponsored links, advertisements of other types, goods, services, or any other items.

Most popular search engines use a type of generalized second price auction (GSP) in order to select sponsored links to place next to search results. The generalized second price auction is well known and is described in the following documents which are incorporated herein by reference:

Edelman, Ostrovsky, Schwarz “Internet advertising and the generalized second price auction: selling billions of dollars worth of keywords.” American Economic Review, 97(1):242-259, March 2007

H Varian “Position auctions.” International Journal of Industrial Organization, October 2006.

Aggarwal, Goel, Motwani “Truthful auctions for pricing search keywords” ACM Conference on Electronic Commerce (EC06), June 2006

The GSP is summarized below to aid understanding of the present invention. Also, several problems with the GSP that are recognized herein are highlighted.

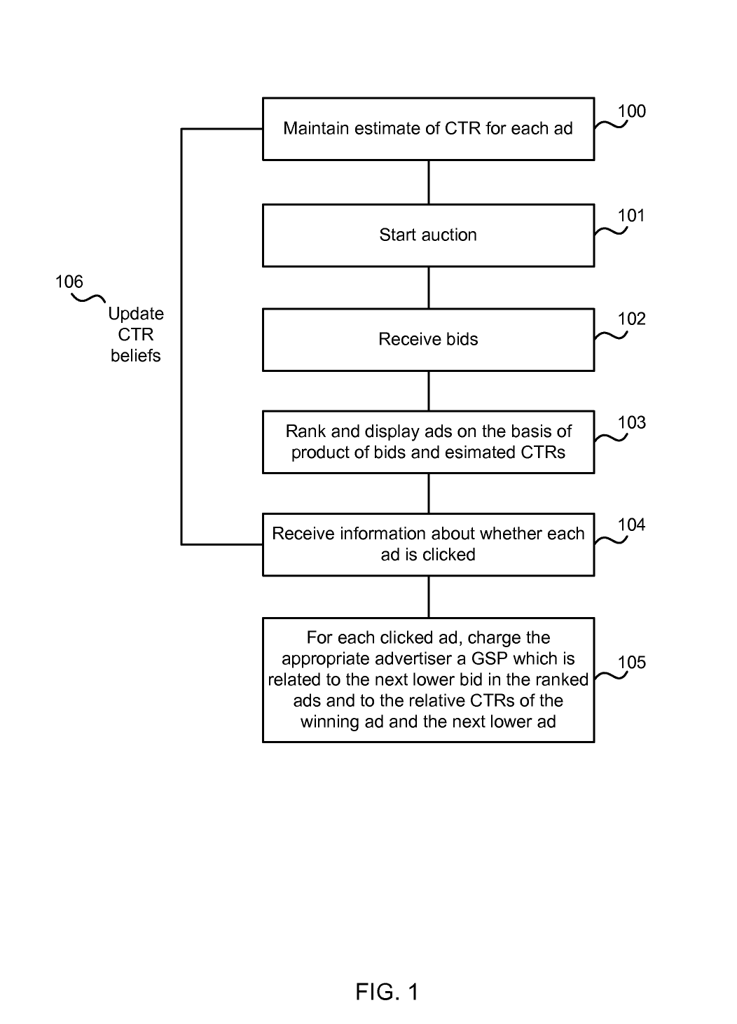

FIG. 1 is a block diagram of an example GSP auction. An automated auction system maintains in memory an estimate of a click-through rate for each of a plurality of advertisements (block 100). Once the auction begins (block 101) bids are received (block 102) from advertisers. Each advertisement is associated with one advertiser who sends in a bid for that advertisement. A processor at the automated auction system ranks (block 103) the advertisements and outputs them to a display such as a web browser at a client computer. The ranking is made on the basis of the product of the bid and estimated click-through rate for each advertisement. The automated auction system receives information about whether each displayed advertisement is clicked or not (block 104) and uses this information to update the CTR estimates (block 106). A price is calculated for each clicked advertisement. This is a generalized second price which is related to the next lower bid in the ranked advertisements and to the relative CTRs of the clicked advertisement and the next lower advertisement.

Thus in a GSP auction an advertiser never pays more than the bid made by that advertiser. Also, an advertiser only pays if the advertisement placed by that advertiser is clicked. Thus in a GSP auction, an advertiser desires a higher CTR because this enables the advertiser to gain a higher ranking whilst bidding less.

In the GSP advertisers submit in each round a bid: a monetary value that they are willing to pay for a click. Instead of ranking by this bid alone, the GSP ranks the ads by the product of bid and click-through rate (CTR). The rationale for this is that an advertiser only pays when his ad is clicked. A high bidding advertiser with a very low click-through rate would, in a bid only ranking, occupy a slot that might be better assigned to a lower bidding but more popular advertiser.

In the event of a click an advertiser pays a generalized second price: the minimal bid that would keep him in the same position. This price is by construction upper bounded by the bid. If the clickthrough rate of an advertiser equals that of the advertiser below him, the price is exactly a second price. If the CTRs are different the price will be slightly different from the next bid. Since a higher click-through rate can compensate a lower bid, it acts as a discount factor. A higher (estimated) click-through rate results in a higher ranking, which is preferred by an advertiser since it empirically leads to more customers, and a lower cost per click.

In contrast to the bid, the click-through rate is not readily observable and needs to be estimated from usage data. However, this is not a typical machine learning problem. The data source in this case is not genuinely random. The advertiser controls partly what data a learning algorithm sees, and can thereby influence the estimation. As discussed above, a higher estimate is preferable for an advertiser, so a straightforward way for an advertiser to manipulate the system is by reincarnating poorly performing ads. When an ad is shown many times and is never, or hardly ever clicked, its CTR estimate will be low. By taking the ad out, constructing a new identity and submitting the ad again, the CTR jumps back up to the initial estimate for an unseen ad. This manipulation of the learning mechanism hinders a correct filtering of poorly performing ads.

The reincarnation problem emphasizes a more general problem with the GSP ad auction. The auction is based on unobservable CTRs, but aims to optimize social welfare (total value of the clicks received by all advertisers) for a single round only. An auction round comprises the process of receiving bids, selecting and presenting ranked sponsored links, receiving clicks and billing advertisers. Many such auction rounds occur as a search engine operates. It is recognised herein that the GSP auction is an approximation in all cases where the CTRs are not known perfectly. A more efficient auction would optimally explore relatively new ads and exploit successful ones while charging both types appropriately.

A computer-implemented automated system for executing the GSP auction may be provided. Modifications to the system for automating the auction process and also to the system for learning the CTRs may be made in order to achieve improvements. For example, the resulting automated auction system may provide a more efficient auction which is able to explore relatively new advertisements and/or to exploit successful advertisements whilst charging both types appropriately. The computer-implemented automated auction system may be integral with a search engine although this is not essential.

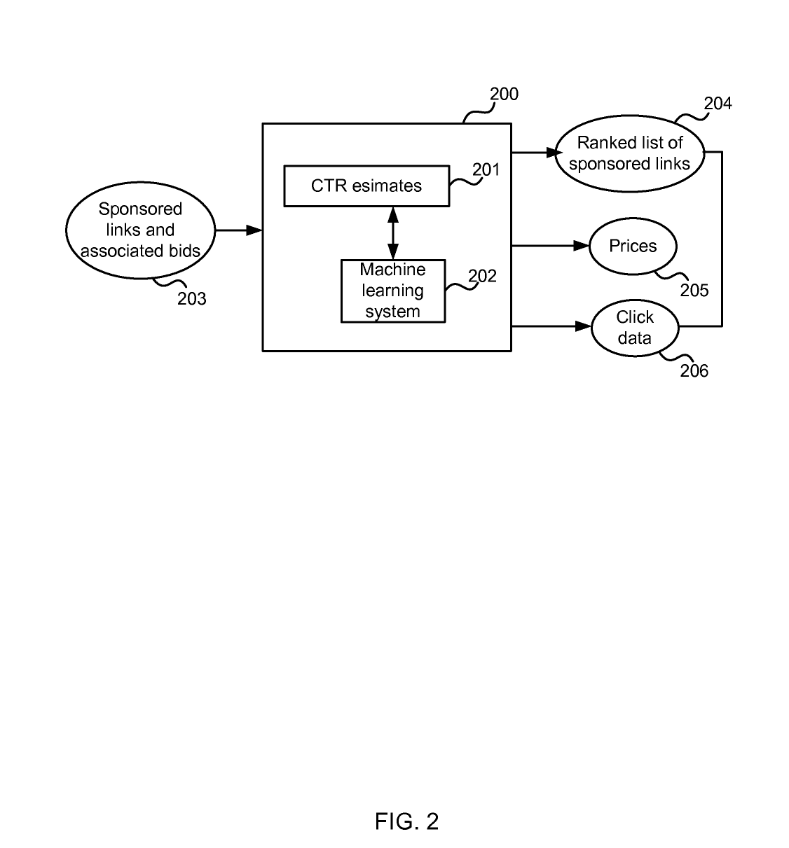

FIG. 2 is a schematic diagram of an automated auction system 200 suitable for implementing the embodiments described herein. It comprises a machine learning system 202 implemented on a computer or other processor of any suitable type. The automated auction system stores CTR estimates 201 for each of a plurality of advertisements.

Inputs to the automated auction system comprise sponsored links or other advertisements and associated bids for those advertisements 203. Other inputs comprise click data 206. Outputs from the automated auction system comprise a ranked list of sponsored links 204 or other advertisements. The list may comprise only one sponsored link or advertisement in some cases. Prices 205 are also output.

The machine learning system comprises a stored model representing the auction process and a processor arranged to train and/or update this model during use as well as to apply the model to carry out the auction process. Details of this model are now given.

In an embodiment, the automated auction system model is arranged to select an advertisement aε1, . . . , A for a single slot in an infinite number of rounds t=1, 2, . . . . That is, in this example, only one advertisement or sponsored link (one slot) is selected by the auction system in each round where a round is the process whereby the auction system receives bids, selects an advertisement, presents that advertisement alongside search results or in any other manner, (optionally) monitors for click data and generates a price for the presented advertisement. There are many such rounds made by the automated auction system during operation. Presentation of an advertisement or sponsored link is referred to herein as an impression. In the GSP an advertiser is only charged if that advertiser's sponsored link is clicked. However, in embodiments of the present invention an advertiser may be charged on a per impression basis; that is, each time the advertiser's sponsored link is presented the advertiser is charged. The term “click data” is used to refer to information about whether a sponsored link, advertisement or other item is selected by a user. The user may be a human user or an automated user. Similarly, an advertiser may be a human, an enterprise or an automated entity.

In embodiments described herein a binary random variable cₐ^{t}ε{0,1} is used by the machine learning system to represent a click event for an advertisement a in round t where the click event is whether the advertisement was selected by a user or not. If the click-through rate associated with a given advertisement a is represented as a πₐε{0,1} then the click event can be considered to be Bernoulli distributed

$$p ( {c}_{a}^{t} \vert {π}_{a} ) = \{ \begin{matrix}{{π}_{a}^{{c}_{a}^{t}} ( 1 - {π}_{a} )}^{( 1 - {c}_{a}^{t} )} & if a is shown at t \\ {1}_{{c}_{a}} = 0 & otherwise\end{matrix} \qquad ( 1 )$$

Where 1 represents the indicator function:

$$1 ( p ) = \{ \begin{matrix}1 & if p is true \\ 0 & otherwise\end{matrix}$$

In embodiments described herein the auction system is arranged to model, for each advertisement a, a private value for a click. This represents a price that the advertiser associated with that advertisement is willing to pay for a click on the advertisement. The price is private and known only to the advertiser and is not the same as the bid. This private value is represented herein as uₐεR+

The auction system may also be arranged to model a time value of money that the advertisers have. That is, the monetary value to an advertiser of a click on an advertisement is assumed to be maximum at the present moment and to decrease with time. The auction system models this using a discounting rate 0≦γ≦1.

The machine learning system may be arranged to model a utility that an advertiser, with associated advertisement a, receives at round t as:

rₐ^{t}=uₐcₐ^{t}

This can be thought of as the reward to an advertiser of having his or her advert clicked. It is the advertisers private monetary value of a click multiplied by the likelihood that the advertisement will be clicked. If the advertisement is not presented then this reward value is zero.

In embodiments of the present invention the machine learning system is arranged to model the situation over many anticipated future rounds rather than just one round of the auction. It is arranged to model the total utility for an advertiser who has associated advert a as:

$${R}_{a} = {\sum }_{t = 1}^{∞} {ϒ}^{t - 1} {r}_{a}^{t}$$

In some embodiments the automated auction system stores and maintains estimates of the click-through rate πₐ^{t} of each advertisement a. The machine learning system models the probability of click-through rate for an advertisement a using a Beta distribution (as described in Pattern Recognition and Machine Learning, Christopher M. Bishop, Springer (2006) ISBN 0-38-731073-8 which is incorporated herein by reference).

p(πₐ)=Beta(α¹ₐβ¹_{α})

Combined with the Bernoulli click observation model in equation 1 above Bayesian update rules may be used by the machine learning system as described below.

At each round t the expected CTR for a is given by

$${\hat{π}}_{a}^{t} ≡ {E}_{p ( {c}_{a}^{t} \vert {c}_{a}^{1 \text{:} t - 1} )} [ {c}_{a}^{t} ] = \frac{{α}_{a}^{t}}{{α}_{a}^{t} + {β}_{a}^{t}} .$$

The ranking is based on the product of bid b and estimated CTR. With the convention that the highest ranking ad is indexed highest this ranking is

b₁^{t}\hat{π}₁^{t}>b₂^{t}\hat{π}₂^{t}> . . . >b^{t}_{A}\hat{π}^{t.}_{A}.

In the single slot case, the selected ad is

$${a}^{*} ≡ {a}_{1} = \text{arg} {max}_{a} [ {b}_{a}^{t} {\hat{π}}_{a}^{t} ] .$$

The price pₐ^{t}* that a* pays for a click is given by the lowest possible bid that would ensure the same position. Substituting pₐ^{t}* for the bid and noting that the lowest bid that would guarantee the same position renders the inequality into an equality it is seen that the generalized second price follows from

pₐ^{t}*\hat{π}ₐ^{t}*=\hat{π}ₐ₍₂₎^{t}bₐ₍₂₎^{t} and hence is given by

$${p}_{{a}^{*}}^{t} = \frac{{\hat{π}}_{a ( 2 )}^{t} {b}_{a ( 2 )}^{t}}{{\hat{π}}_{{a}^{*}}^{t}} .$$

The form of the generalized second price auction for a single slot that we have discussed above is summarized below.

At t=1

The auction system assigns prior CTR beliefs

p(cₐ^{t})=Beta(αₐ^{t},βₐ^{t})

for all advertisers aε1, . . . , A.

At each round t=1, . . .
All advertisers aε1, . . . , A submit a bid bₐ^{t},
The auction system places the ad a* that maximizes the expected single round reward for all advertisers

$${a}^{*} = \text{arg} max {E}_{p ( {c}_{a}^{t} \vert {c}_{a}^{1 \text{:} - 1} )} [ {b}_{a}^{t} {c}_{a}^{t} ]$$

based on the reported values (i.e. bids) for a click bₐ^{t}.
Advertiser a* is charged, if his ad is clicked, the smallest bid that would guarantee him the same slot

$${p}_{{a}^{*}}^{t} = \frac{{\hat{π}}_{a ( 2 )}^{t} {b}_{a ( 2 )}^{t}}{{\hat{π}}_{{a}^{*}}^{t}} .$$

He is charged 0, if his ad is not clicked.
Based on the click events, the auction system performs the exact Bayesian updates

$$\begin{matrix}{α}_{a}^{t + 1} = \{ \begin{matrix}{α}_{a}^{t} + 1 & if a = {a}^{*} and {c}_{a}^{t} = 1 \\ {α}_{a}^{t} & otherwise\end{matrix} & ( 2 ) \\ {β}_{a}^{t + 1} = \{ \begin{matrix}{β}_{a}^{t} + 1 & if a = {a}^{*} and {c}_{a}^{t} = 1 \\ {β}_{a}^{t} & otherwise\end{matrix} & ( 3 )\end{matrix}$$

It is recognized herein that the GSP mechanism is greedy in that it assigns advertisements to maximize the utility of advertisers for the present round only. This is addressed herein by arranging the automated auction system to maximize the total expected utility over all advertisers and all anticipated future rounds. This is achieved by arranging the automated auction system to carry out a process which is based on a dynamic Vickrey-Clarke-Groves (VCG) mechanism as described in Bergmann and Valimaki “Dynamic marginal contribution mechanism” Technical report, Cowles Foundation for research in Economics, June 2007 which is incorporated herein by reference.

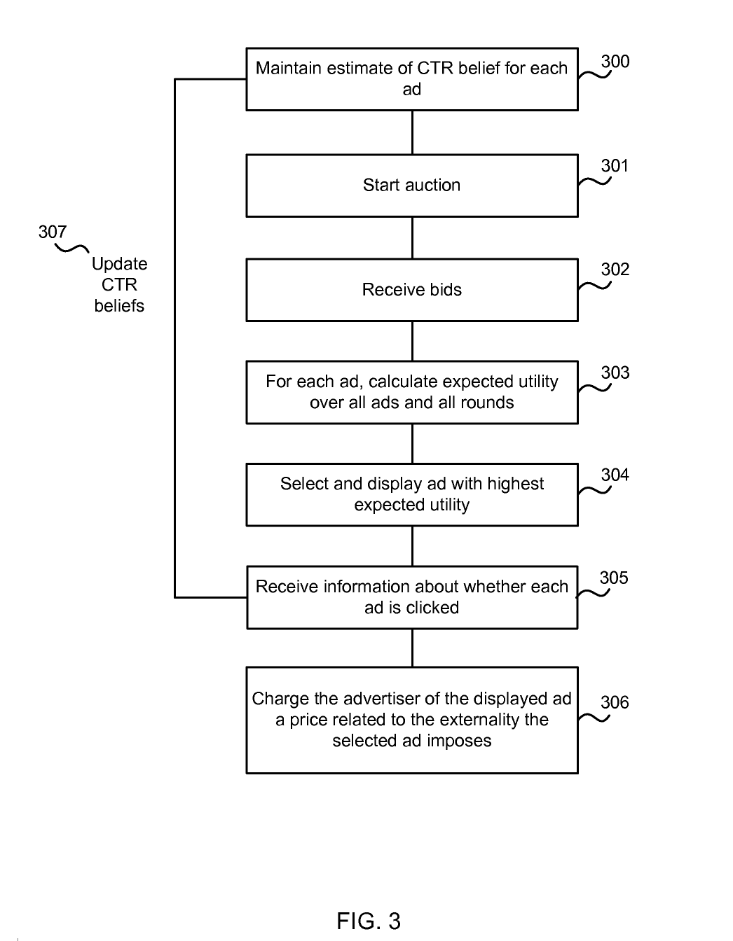

In an embodiment the automated auction system is arranged to carry out a computer-implemented method as now described with reference to FIG. 3. An estimate of a CTR belief is maintained for each of a plurality of advertisements (block 300). In some embodiments the advertisers are requested to submit their belief as to the click-through rate for their advertisement. In other embodiments the automated auction system uses its own best estimates of these click-through rates. The auction begins (block 301) and bids are received (block 302) with one bid being received for each advertisement. For each advertisement, an expected utility is calculated over all advertisements and all rounds of the auction (block 303). The automated auction system selects and outputs to a display an advertisement with the highest expected utility (block 304). Information is received about whether each advertisement is clicked (block 305) and this information is used to update the CTR belief estimates (block 307). Prices are then calculated for the displayed advertisements and the advertisers are charged on a per-impression basis. That is, an advertiser is charged each time his or her advertisement is presented no matter whether that advertisement is clicked or not. The charges may optionally be amortized over several rounds. The advertiser of the selected advertisement is charged a price related to the externality that the selected advertisement imposes (block 306) in the present round. The externality is a measure of the value of lost clicks the winning advertisement imposes on other advertisements by pushing the other advertisements down in the ranking of sponsored links in the present round. This is dominated by the missed opportunity for the next highest ranked bidder to attract a customer. The externality can also be thought of as the expected profits foregone by the other advertisers. For example, a measure of the externality is calculated by repeating the process of calculating the total expected discounted sum of rewards (block 303) for each advertisement. This calculation is done over all advertisements and all rounds, except omitting the “winning” advertisement in the current round. A new value of the total expected utility omitting the “winning” advertisement in the given round, is thus obtained and this provides a measure of the externality.

As mentioned above, for each advertisement, an expected utility is calculated over all advertisements and all rounds of the auction (block 303). This utility can also be referred to as a total reward for all adverts and all anticipated future rounds. The rewards may be discounted as described above to represent depreciation in the value of a successfully presented advert to an advertiser over time (rounds of the auction).

Thus in some embodiments of the invention, the process at block 303 of FIG. 3 comprises calculating a total expected discounted sum of rewards for all advertisements and all anticipated future rounds. This may be denoted as:

$$V ( s ) ≡ [ {\sum }_{t = 1}^{∞} {\sum }_{a = 1}^{A} {γ}^{t - 1} {r}_{a}^{t} ] \qquad ( 4 )$$

given a reported state

s≡{bₐ,αₐ,βₐ|aε1, . . . A}.

The expectation in (4) is with respect to the joint distribution over all the click events. The social welfare V(s) can be expressed recursively as

$$\begin{matrix}V ( {s}^{t} ) = {max}_{a ∈ 1 , … , A} Q ( {s}^{t} , a ) & ( 5 ) \\ Q ( {s}^{t} , a ) = {\hat{π}}_{a}^{t} [ {b}_{a}^{t} + γ V ( {s}_{+}^{t + 1} ) ] + ( 1 - {\hat{π}}_{a}^{t} ) [ γ V ( {s}_{-}^{t + 1} ) ] . & ( 6 )\end{matrix}$$

In the above s₊^{t+1} and s₋^{t+1} are shorthands for the state St updated according to a click and a non-click respectively using Equations (2) and (3) above.

To represent the social welfare with a* not present equivalents of (5) and (6) are used with a* excluded

$${V}_{\backslash {a}^{*}} ( {s}^{t} ) = {max}_{a ∈ \{ 1 , … , A \} \backslash \{ {a}^{*} \}} {Q}_{\backslash {a}^{*}} ( {s}^{t} , a )$$

$${Q}_{\backslash {a}^{*}} ( {s}^{t} , a ) = {\hat{π}}_{a}^{t} [ {b}_{a}^{t} + γ {V}_{\backslash {a}^{*}} ( {s}_{+}^{t = 1} ) ] + ( 1 - {\hat{π}}_{a}^{t} ) [ γ {V}_{\backslash {a}^{*}} ( {s}_{-}^{t + 1} ) ] .$$

To determine the externality a* imposes, we first look at the expected return for all other agents when a* participates in round t (only). In round t agent a* is shown, so the others receive a direct reward of 0. From the next round on the remaining agents are assigned optimally yielding an expected return of V_{\a}* (s^{t+1}). When showing a* the elements in the state for the other agents will not be updated so V_{\a}* (s^{t+1})=V_{\a} (s^{t}). Combining the one-step and future returns, it is seen that the expected return for the other agents when a* participates in round t is 0+γV_{\a} (s^{t}). Consider now the expected return for all other agents when a* is excluded completely. In this case a₂ is shown in round t, and the expected return for the agents is V_{\a} (s^{t}). The price a* pays for round t is his externality and is given by the difference between the above two quantities.

$${p}_{{a}^{*}}^{t} = {V}_{\backslash {a}^{*}} ( {s}^{t} ) - γ {V}_{\backslash {a}^{*}} ( {s}^{t} ) \\ = ( 1 - γ ) {V}_{\backslash {a}^{*}} ( {s}^{t} ) . \qquad ( 7 )$$

Another way of interpreting the externality a* imposes on the remaining advertisers by participating in round t only, is that they have to wait a round to resume optimal play and expect to receive V_{\a} (s^{t}).

An advertiser pays a per-impression cost. Just by occupying a slot an advertiser imposes an externality onto society. This externality is dominated by the missed opportunity for the next highest ranked bidder to attract a customer. But in addition to this, the selected advertiser also prevents the next highest bidder from learning about his click-through rate. Expanding (7) one step, and using the fact that a₂ is selected if a* is not present, we get that the opportunity cost for missed exploration is

γ(\hat{π}ₐ₍₂₎^{t}V₋ₐ*(s₊^{t})+(1−\hat{π}ₐ₍₂₎^{t})V₋ₐ*(s₋^{t})−V₋ₐ*(s^{t})).

An example method at an automated auction system is now described.

At t=1
The auction system provides default CTR beliefs

p(cₐ^{t})=Beta(αₐ^{t},βₐ^{t}).
for all advertisers a.

At each round t=1
All advertisers aε1, . . . , A submit
   a bid bₐ^{t},
   and optionally CTR belief parameters αₐ^{t}, βₐ^{t} that override default values of these parameters stored at the auction system.
The auction system places the ad a* that maximizes the total expected reward for all advertisers and all rounds

$${a}^{*} = \text{arg} {max}_{a} E [ Q ( {s}^{t} , a ) ] \qquad ( 8 )$$

based on the state

s^{t}≡{bₐ^{t},αₐ^{t},βₐ^{t}|aε1, . . . A}
as it is reported by the advertisers.
Advertiser a* is charged for this round the externality he imposes in this round

pₐ^{t}*=(1−γ)V₋ₐ*(s₋ₐ^{t}*)
even if his ad is not clicked.
Based on the click events, the center performs the exact Bayesian updates

$$\begin{matrix}{α}_{a}^{t + 1} = \{ \begin{matrix}{α}_{a}^{t} + 1 & if a = {a}^{*} and {c}_{a}^{t} = 1 \\ {α}_{a}^{t} & otherwise\end{matrix} \\ {β}_{a}^{t + 1} = \{ \begin{matrix}{β}_{a}^{t} + 1 & if a = {a}^{*} and {c}_{a}^{t} = 0 \\ {β}_{a}^{t} & otherwise .\end{matrix}\end{matrix}$$

As mentioned above the process at block 303 of FIG. 3 comprises calculating a total expected discounted sum of rewards for all advertisements and all rounds. In the case that only a single advertisement is presented in each round and the click probabilities are assumed to be independent it is possible to use a particularly practical implementation method. A Gittins index is computed for each advertisement and the process then involves selecting the advertisement with the highest index. For example, a table of Gittins indices may be pre-computed using a variant of golden section search and an approach to the optimal stopping problem based on Bjulai and Koole “On the value of learning for Bernoulli bandits with unknown parameters.” IEEE Transactions on Automatic Control, 45:2135-2140, 2000 which is incorporated herein by reference. As is observed in Cavallo et al. “Optimal coordinated planning amongst self-interested agents with private state.” In Proceedings of UAI, 2006 (which is incorporated herein by reference) an unbiased estimate of V₋ₐ*(s) such as obtained from sampling may be used.

The embodiments described above are described for clarity with respect to the single slot case where only a single advertisement is selected for presentation. However, it is also possible to scale the method up to select more that one advertisement and rank those advertisements according to the total expected discounted sum of rewards for all advertisements and all rounds. Computational expense increases in this case however.

In finite horizon cases, where the number of future auction rounds is known for example, the methods described herein may readily be extended to multiple slots (i.e. where a plurality of ranked sponsored advertisements are presented at each round). In infinite horizon cases, where the number of future auction rounds continues indefinitely, computational expense introduces a practical limitation on implementing the auction system.

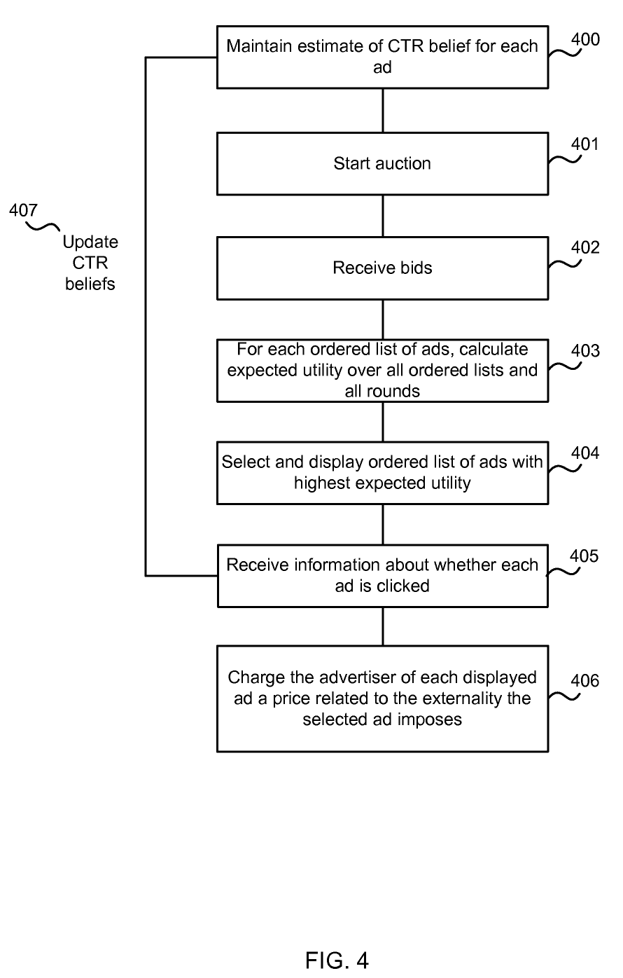

An example of a multiple slot embodiment is now described with reference to FIG. 4. A click through rate belief for each advertisement is maintained 400 as described above with reference to FIG. 3. The auction begins 401 and bids are received 402 for advertisements. The auction system considers all potential ordered lists of the advertisements. For example, in the case three slots are used, then all combinations of groups of three of the possible advertisements are considered. For each of these potential ordered lists of advertisements an expected utility is calculated 403 over all the ordered lists and all rounds. The ordered list with the highest expected utility is selected and displayed. Information about whether each advertisement is clicked is received 405 and optionally used to update 407 the CTR belief estimates. The advertisers are charged 406 in a similar manner to that described above with reference to FIG. 3.

The embodiments described above which are based on a dynamic-VCG mechanism are efficient and truthful. Efficiency refers to the fact that the auction assigns advertisements in such a way that it maximizes the expected sum of rewards over all time steps and all advertisements. The notion of truthfulness refers to the fact that it is optimal for advertiser a to report his true bid and CTR belief given that the other advertisers report truthfully as well. This reduces the ability of advertisers to manipulate the auction by resubmitting advertisements because the process considers all rounds of the auction. For example, if an advertiser decides to be optimistic about his click-through rate, his advertisement will be shown more often. However, since he is charged for every impression he will not be able to compensate the costs of the extra impressions by actual customer visits. If an advertiser under-reports his click-through rate he potentially misses opportunities for attracting customers that are to him (in expectation) profitable. Misrepresenting uncertainty about a click-through rate also leads similarly to situations where an advertisement is shown too often or too infrequently.

The embodiments described above which are based on a dynamic-VCG mechanism can be thought of as giving loyalty benefits at exactly the right rate. Every time an advertisement is shown the click-through rate belief is updated and will converge in the limit to a delta-peak at the true click-through rate. An improved estimate results in a better placement policy for the advertiser. If it turns out to be beneficial to be shown more often, the advertisement will be shown more often. If it turns out to be beneficial to be shown less, the advertisement will be shown less.

The robustness against reincarnation helps to filter out poorly targeted advertisements. This improves the end user experience, increases social welfare (total value of the click received by all advertisers) and can increase revenue for the search engine since free or too cheap exploration is suppressed.

In the generalized second price auction advertisers can manipulate the estimates of their click-through rates by reincarnating poorly performing ads. By taking an ad out and resubmitting it under a new name, click-through rates need never fall far below the initial estimate for a new ad. On closer inspection this cheating problem is caused by a general lack of principled exploration and exploitation in the GSP auction. Both the cheating and exploration problems can lead to a loss of revenue and have a negative effect on searchers' experience since (slight variants of) highly untargeted ads will not be filtered out and will be shown to the users indefinitely.

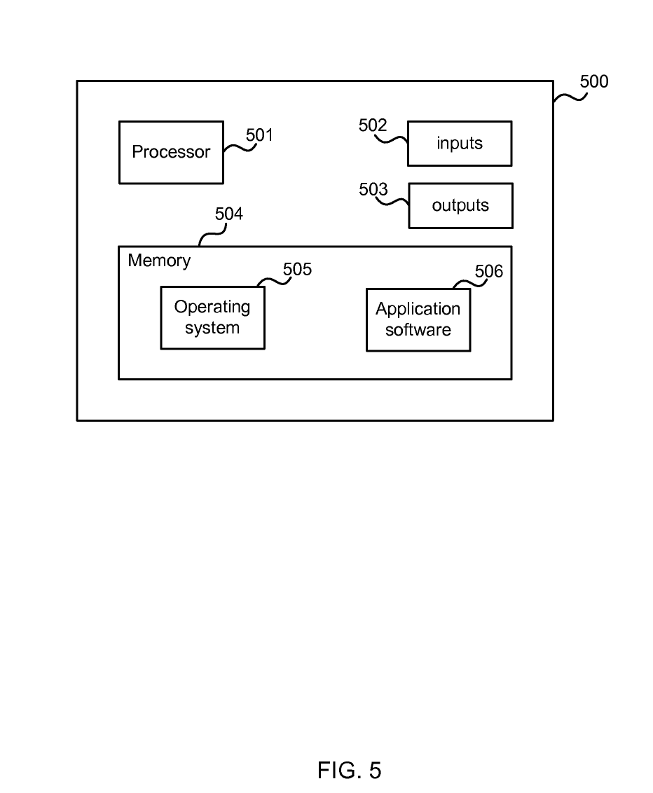

FIG. 5 illustrates various components of an exemplary computing-based device 500 which may be implemented as any form of a computing and/or electronic device, and in which embodiments of an automated auction system may be implemented.

The computing-based device 500 comprises one or more inputs 502 which are of any suitable type for receiving advertisements such as sponsored links as well as bids and click data and click-through estimates.

Computing-based device 500 also comprises one or more processors 501 which may be microprocessors, controllers or any other suitable type of processors for processing computing executable instructions to control the operation of the device in order to provide an automated auction system. Platform software comprising an operating system 505 or any other suitable platform software may be provided at the computing-based device to enable application software 506 to be executed on the device.

The computer executable instructions may be provided using any computer-readable media, such as memory 504. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output 503 is also provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of selecting an ordered list of advertisements from a plurality of advertisements during a round of an auction the method comprising the steps of:
for each advertisement, receiving a bid
for each advertisement, accessing information about an estimate of a click-through rate for that advertisement;
for each of a plurality of ordered lists of advertisements, calculating a total expected utility over all the ordered lists of advertisements and all anticipated future rounds of the auction;
selecting one of the ordered lists of advertisements on the basis of the calculated total expected utility values;
outputting the selected ordered list of advertisements as winners of the round of the auction.

2. A method as claimed in claim 1 wherein the step of calculating the total expected utility comprises calculating a total expected discounted sum of rewards for all ordered lists of advertisements and all anticipated future rounds of the auction.

3. A method as claimed in claim 1 wherein the step of calculating the total expected utility comprises using a pre-computed Gittins index for each advertisement.

4. A method as claimed in claim 1 which further comprises, for each advertisement, receiving the click-through rate estimate for that advertisement from an advertiser associated with the advertisement.

5. A method as claimed in claim 1 which further comprises receiving information about whether the selected advertisement is clicked and using that information to update the estimated click-through rates.

6. A method as claimed in claim 1 which further comprises charging an advertiser associated with an advertisement in the selected ordered list of advertisements on a per-impression basis.

7. A method as claimed in claim 1 which further comprises calculating a price to charge an advertiser associated with an advertisement in the selected list of advertisements, that price being related to the externality imposed by the advertisement in the round of the auction.

8. A method as claimed in claim 7 wherein the price is calculated by calculating a total expected discounted sum of rewards for all ordered lists of advertisements and all anticipated future rounds of the auction whilst omitting the advertisement associated with the advertiser in the round of the auction.

9. A computer-implemented method of selecting an advertisement from a plurality of advertisements during a round of an on-line auction the method comprising the steps of:
for each advertisement, receiving a bid;
for each advertisement, accessing information about an estimate of a click-through rate for that advertisement;
for each advertisement, calculating a total expected discounted sum of rewards for all advertisements and all anticipated future rounds of the auction as follows:
$$V ( s ) ≡ [ {\sum }_{t = 1}^{∞} {\sum }_{a = 1}^{A} {γ}^{t - 1} {r}_{a}^{t} ]$$
for a reported state
s≡{bₐ,αₐ,βₐ|aε1, . . . A}.
where, t represents a round of the auction, a represents an advertisement, γ is a discounting rate, r represents a reward to an advertiser of having his or her advertisement clicked, b represents a bid, and α and β are parameters of a beta distribution representing belief about a click-through rate;
selecting one of the advertisements on the basis of the calculated total expected discounted sum of rewards values; and
outputting the selected advertisement as a winner of the round of the auction.

10. A method as claimed in claim 9 wherein the step of calculating the total expected discounted sum of rewards comprises using a pre-computed Gittins index for each advertisement.

11. A method as claimed in claim 9 which further comprises, for each advertisement, receiving the click-through rate estimate for that advertisement from an advertiser associated with the advertisement.

12. A method as claimed in claim 9 which further comprises receiving information about whether the selected advertisement is clicked and using that information to update the estimated click-through rates.

13. A method as claimed in claim 9 which further comprises charging an advertiser associated with the selected advertisement on a per-impression basis.

14. A method as claimed in claim 9 which further comprises calculating a price to charge an advertiser associated with the selected advertisement, that price being related to the externality imposed by the selected advertisement in the round of the auction.

15. A method as claimed in claim 14 wherein the price is calculated by calculating a total expected discounted sum of rewards for all advertisements and all anticipated future rounds of the auction whilst omitting the previously selected advertisement in the round of the auction

16. One or more device-readable media with device-executable instructions for performing steps comprising:
for each of a plurality of advertisements, receiving a bid during a round of an auction;
for each advertisement, accessing information about an estimate of a click-through rate for that advertisement;
for each of a plurality of ordered lists of the advertisements, calculating a total expected utility over all the ordered lists of advertisements and all anticipated future rounds of the auction;
selecting one of the ordered lists of advertisements on the basis of the calculated total expected utility values; and
outputting the selected ordered lists of advertisement as winners of the round of the auction.

17. One or more device-readable media as claimed in claim 16 with device-executable instructions for performing steps comprising: forming the ordered lists such that each list has the same number of advertisements and such that all possible combinations of ordered lists having that number of advertisements are formed.

18. One or more device-readable media as claimed in claim 16 with device-executable instructions for performing steps comprising: calculating the total expected utility by calculating a total expected discounted sum of rewards for all the ordered lists of advertisements and all anticipated future rounds of the auction.

19. One or more device-readable media as claimed in claim 16 with device-executable instructions for performing steps comprising charging an advertiser associated with an advertisement in the list of selected advertisements on a per-impression basis.

20. One or more device-readable media as claimed in claim 16 with device-executable instructions for performing steps comprising using a pre-computed Gittins index for each advertisement during the calculation of the total expected utility.
